(19) United States
(12) Patent Application Publication
(10) Pub. No.: US 2011/0278852 A1
(43) Pub. Date: Nov. 17, 2011

(54) WIND TURBINE NACELLE

(75) Inventor: Thomas Hjort, Vejle Ost (DK)

(73) Assignee: VESTAS WIND SYSTEMS A/S, Randers SV (DK)

(21) Appl. No.: 13/139,905

(22) PCT Filed: Dec. 11, 2009
(86) PCT No.: PCT/DK09/00253

§ 371 Date: Aug. 1, 2011

Related U.S. Application Data
(60) Provisional application No. 61/122,790, filed on Dec. 16, 2008.

(30) Foreign Application Priority Data
Dec. 16, 2008 (DK) PA 2008 01790

(51) Int. Cl. F03D 11/04; F03D 9/00

(52) U.S. Cl. 290/55; 415/213.1

(57) ABSTRACT

According to the present invention is provided a wind turbine nacelle comprising wind turbine components. The nacelle also comprises a load carrying structure including a base member (21) establishing a connection between the wind turbine rotor and tower, at least one tie member (22), and at least one strut member (19) carrying one or more of said wind turbine components. The tie and strut members are connected at one end to each other and at the opposite ends to different positions on the base member for establishing one or more closed structures.

The present invention relates to a wind turbine nacelle and a wind turbine.

### BACKGROUND

The nacelle of a modern wind turbine may comprise a number of components weighing more than one ton such as the gearbox, electric generator, power converter and transformer, respectively.

Further, different distances are needed between the components e.g. in order to fulfil the structural or safety requirements. The mechanical and electrical energy transferred from the rotor to the transformer is of such significance that the components need to be positioned in alignment i.e. resulting in a rather long and slender nacelle on top of the tower.

The heavy components distributed in the long nacelle require a strong nacelle structure and accompanying yaw mechanism in order to continuously sustain and transfer the induced forces i.e. also resulting in a nacelle structure adding significantly to the total weight of the nacelle.

An object of the present invention is therefore to provide a wind turbine nacelle with an improved structure and especially in relation to transfer of forces.

### BRIEF DESCRIPTION OF THE INVENTION

According to the present invention is provided a wind turbine nacelle comprising

wind turbine components, and
a load carrying structure including
a base member structurally establishing a connection between the wind turbine rotor and tower,
at least one tie member, and
at least one strut member carrying one or more of said wind turbine components,
wherein tie and strut members are connected at one end to each other and at the opposite ends to different positions on the base member for establishing one or more closed structures.

By the closed load carrying structure it is possible to establish a nacelle without of torque loads i.e. a structure with a more simple force distribution by solely comprising linear forces of compression and tension.

In an aspect of the invention said one or more closed structure is triangular, substantially triangular in shape or at least has a triangular transfer of forces with said tie member as the upper triangle side which ensures a simple and strong structure in the nacelle.

In another aspect of the invention said at least one tie member is one or more lightweight beams, cable stays or wires. By the use of a lightweight connection between the strut and base member is established a well-equipped solution in sustaining the tension from the carried wind turbine components on the strut member.

In an aspect of the invention said strut member is inclined in relation to a horizontal plane by an angle α in a range of 15 to 75° such as approx. 45°. Hereby is ensured an advantageous relation between tension and compression as well as outer shape of the nacelle. Especially the avoidance of very acute angles is advantageous as load concentrations are prevented in the closed structure.

In another aspect of the invention the number of said at least one strut member is one centrally situated member in relation to the nacelle sides and orientated toward the rear of the nacelle. Hereby is established a lightweight nacelle structure with the possibility of positioning the wind turbine components such as an electric generator on top of or below the member as well as attached on one or both sides e.g. as two separate generators for the same gearbox. Other multiple configurations of a wind turbine component on opposite side of the member and behind or in front of another heavy component are also possible.

In a further aspect of the invention the number of said at least one strut member is two members at the nacelle sides e.g. parallel in direction or orientated to meet at the rear of the nacelle. Hereby is established a strong nacelle structure with sufficient space between the members for components as well as passages for people servicing the components.

One or more of electric generators, power converters and transformers are carried by said at least one strut member in an even further aspect of the invention. The layout, configuration and manufacturing of the nacelle are simplified by the strut member being capable of carrying most of or all of said wind turbine component i.e. establishing one straight line of components behind the gearbox without creating torque in the nacelle structure.

In an aspect of the invention the transformer is suspended from said component carrying member in a suspension arrangement including a shaft attachment and one or more movement dampers and/or actuators. The suspension arrangement ensures that the transformer is allowed to swing in a controlled manner in response to any nacelle vibrations and thus avoid fatigue in the suspension of the transformer. Further, the actuators may be used to control the movement of the transformer in an active damping of vibrations in the transformer or in the wind turbine as such.

In further aspects of the invention said suspension arrangement being suspended to said component carrying member in a flexible joint connection and/or includes a flexible joint connection allowing the transformer to sway and/or said flexible joint connection is a cardan, ball or similar universal coupling joint. Hereby are advantageous embodiments of the invention achieved and especially as the transformer is partly or totally decoupled from any vibrations of the nacelle ensuring that the transformer is not amplifying the vibrations

### FIGURES

The invention will be described in the following with reference to the figures in which

FIG. 1 illustrates a large modern wind turbine as known in the art,

FIG. 2 illustrates a simplified cross sectional view of a well-known wind turbine nacelle, as seen from the side,

FIG. 3 illustrates schematically a wind turbine nacelle with a load carrying structure, as seen from the side,

FIG. 4 illustrates the wind turbine nacelle of FIG. 3 with more details,

FIGS. 5a and 5b illustrate schematically another embodiment of the load carrying structure in the nacelle,

FIG. 6 illustrates a sectional view of a suspension arrangement for suspending a transformer in a load carrying structure of the wind turbine nacelle, and

FIG. 7 illustrates a flexible embodiment of the suspension arrangement for a transformer, as seen from the rear of the nacelle.

### DETAILED DESCRIPTION OF RELATED ART

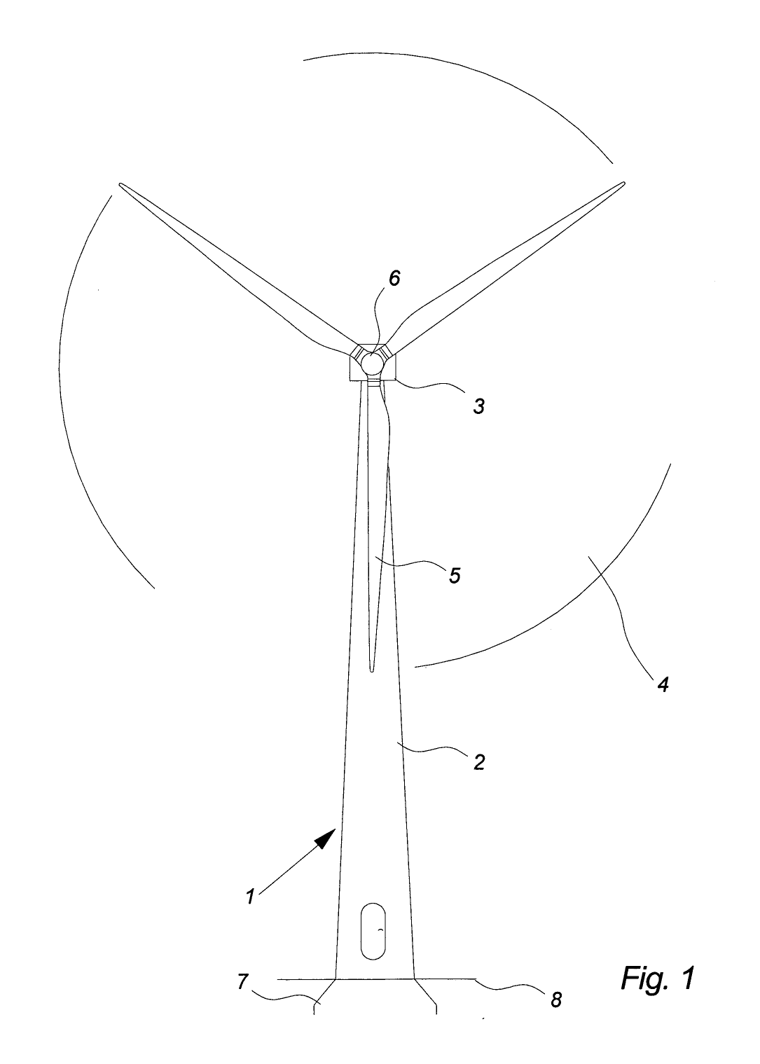

FIG. 1 illustrates a large modern wind turbine 1 as known in the art, comprising a tower 2 and a wind turbine nacelle 3 positioned on top of the tower 2. In this embodiment the wind turbine rotor 4 comprises three wind turbine blades 5 mounted on a common hub 6 which is connected to the nacelle 3 through the low speed shaft extending out of the nacelle 3 front. In another embodiment the wind turbine rotor 4 could comprise another number of blades 5 such as one, two, four, five or more.

The wind turbine is erected on a concrete foundation 7 mainly positioned below a ground level 8 in order to establish a wind power plant for connection to a utility grid (not illustrated on the figure) transferring the generated power to utility customers.

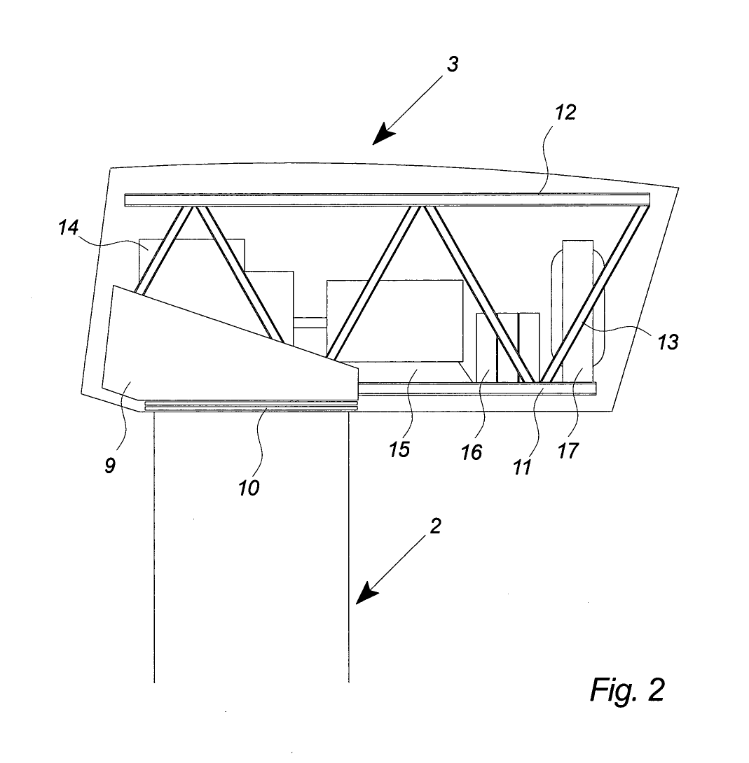

FIG. 2 illustrates a simplified cross sectional view of a nacelle 3, as seen from the side with a number of wind turbine components being present.

The nacelle establishes a force transferring connection between the wind turbine rotor (not illustrated on the figure) and the tower 2 by especially including a bedframe as a bell-shaped member 9 carrying a gearbox 14 and a yaw mechanism 10 allowing a rotational connection to the tower.

The illustrated nacelle also includes two sets of horizontal orientated lower and upper side beams 11, 12 wherein the lower beams 11 are attached to the bell-shaped member 9. The lower and upper beams 11, 12 are directly or indirectly connected by a number of further beams 13 in order to establish a nacelle structure.

A floor level support structure is established between the two lower side beams 11, 12 in order to carry further wind turbine components such as the electric generator 15, the power converter 16 (illustrated as a number of converter units) and a transformer 17.

The transformer 17 transforms the electric power generated by the generator 15 and converted by the power converter 16 to a different high voltage level for feeding the power to the utility grid.

### DETAILED DESCRIPTION OF THE INVENTION

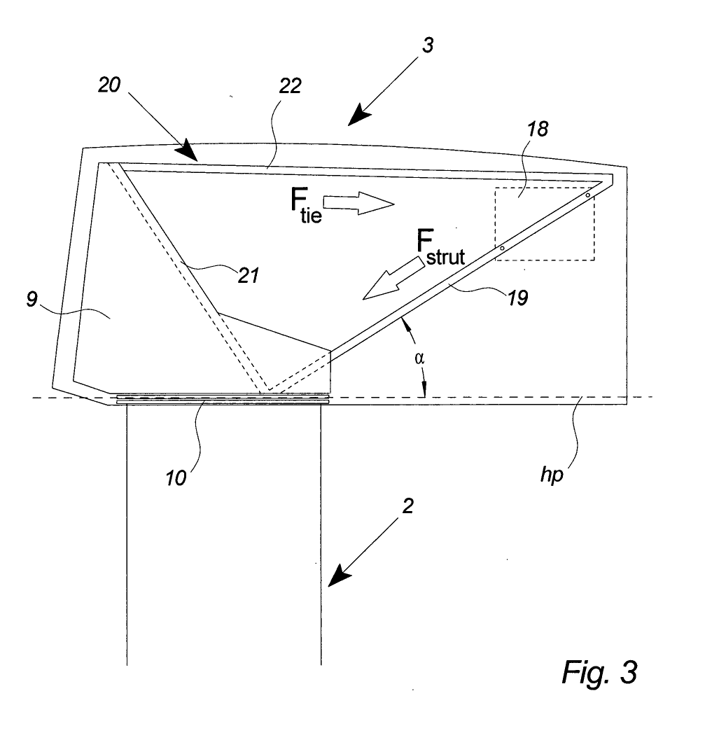

FIG. 3 illustrates schematically a wind turbine nacelle with a load carrying structure 20, as seen from the side, with a connection to the wind turbine tower 2 via the yaw mechanism 10.

The nacelle load carrying structure is illustrated as a closed structure having a triangular shape defined by a base member 21 including the bell-shaped bedframe 9, a strut member 19 and a tie member 22.

The nacelle may comprise one or two triangular shaped structures e.g. with the strut member 19 centrally located or located at both nacelle sides, respectively.

The nacelle may also comprise more than two triangular shaped structures e.g. one centrally located and two located at the nacelle sides.

The strut member 19 is inclined in relation to a horizontal plane (illustrated with the dotted line) by an angle α e.g. in a range of 15 to 75° such as approx. 45° orientated toward the rear of the nacelle.

The strut member 19 is schematically illustrated with one wind turbine component 18 such as an electric generator, power converter or transformer attached to the member 19.

The weight of the wind turbine component is converted to a force compressing the strut member 19 (illustrated with the arrow Fₛₜᵣᵤₜ) and tensioning the tie member 22 (illustrated with the arrow Fₜᵢₑ) in relation to the two different connection positions on the base member 21 and the bedframe 9. The forces are transferred with the rigid connection established by the bedframe, yaw mechanism and tower 2 to the wind turbine foundation.

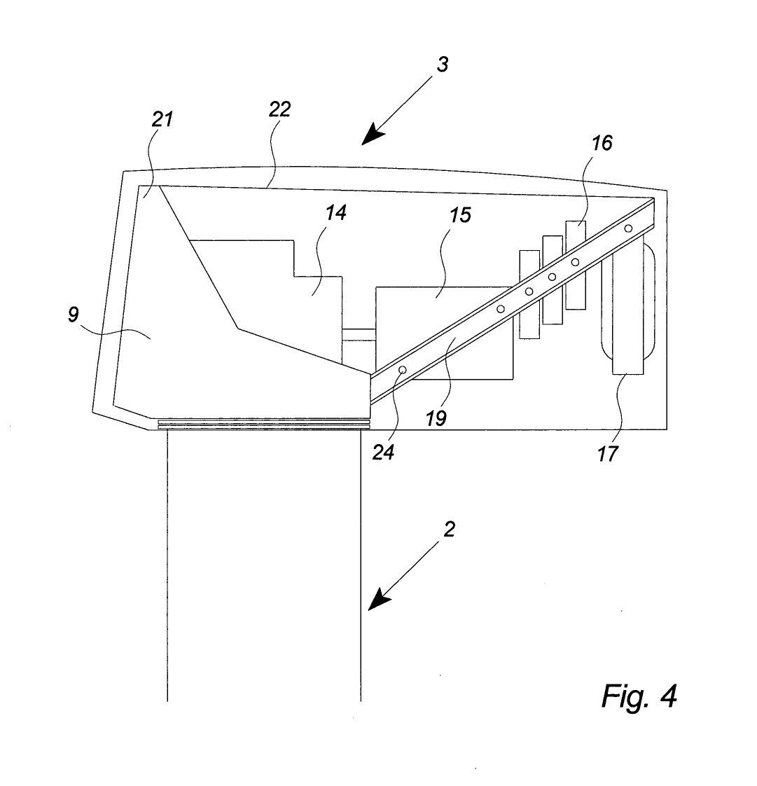

FIG. 4 illustrates the wind turbine nacelle of FIG. 3 including a number of wind turbine components attached to the strut member 19.

The generator 15 is illustrated as being the first wind turbine component attached to the strut member 19 with use of connection means 24 such as bolts, rods or similar attachment means.

Behind the electric generator are attached a number of units in the power converter 16 and finally the transformer 17 attached at the end of the strut member 19. The end of the strut member 19 is also attached to the tie member 22 which is illustrated in this embodiment as a cable stay or wire instead of a lightweight metal beam as illustrated in FIG. 3.

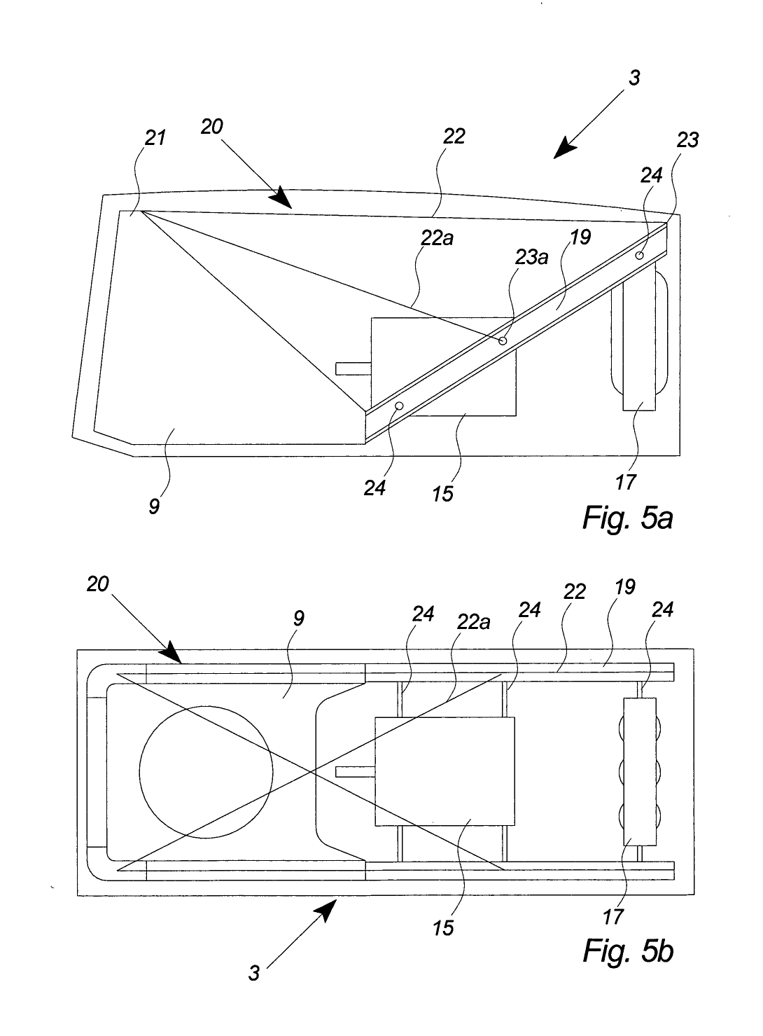

FIGS. 5a and 5b illustrate schematically another embodiment of the load carrying structure 20 in the nacelle 3.

FIG. 5a illustrates the load carrying structure of the nacelle, as seen from the side, with only the generator 15 and the transformer 17 present for clarity purposes.

The figure also illustrates a further cable stay 22a complementing the cable stay 22 of FIG. 4 i.e. adding a bridge like suspension to the structure by using two (or more) cable stays. The cable stays are connected to the structure in connection points 23, 23a on the strut member 19 e.g. in proximity of the connection means 24 for the wind turbine components.

FIG. 5b illustrates the embodiment of FIG. 5a as seen from above.

The added cable stays 22a are illustrated in the embodiment as diagonally connecting the base frame 20 with the strut member 19 while the cable stays 22 are illustrated as in alignment with the nacelle 3. All the stays may however also be directed diagonally or in alignment with the nacelle 3 in other embodiments of the invention.

The figure also illustrates the connection means 24 such as bolts, rods or similar attachment means between the two wind turbine components 15, 17 and the two strut members 19 of the embodiment.

The nacelle structure comprising strut and tie members may also be provided with a crane system allowing a wind turbine component such as a transformer to be released from the strut member(s) and lowered via a nacelle opening to the ground by the crane and/or elevated from the ground level to the members in an installation or replacement action.

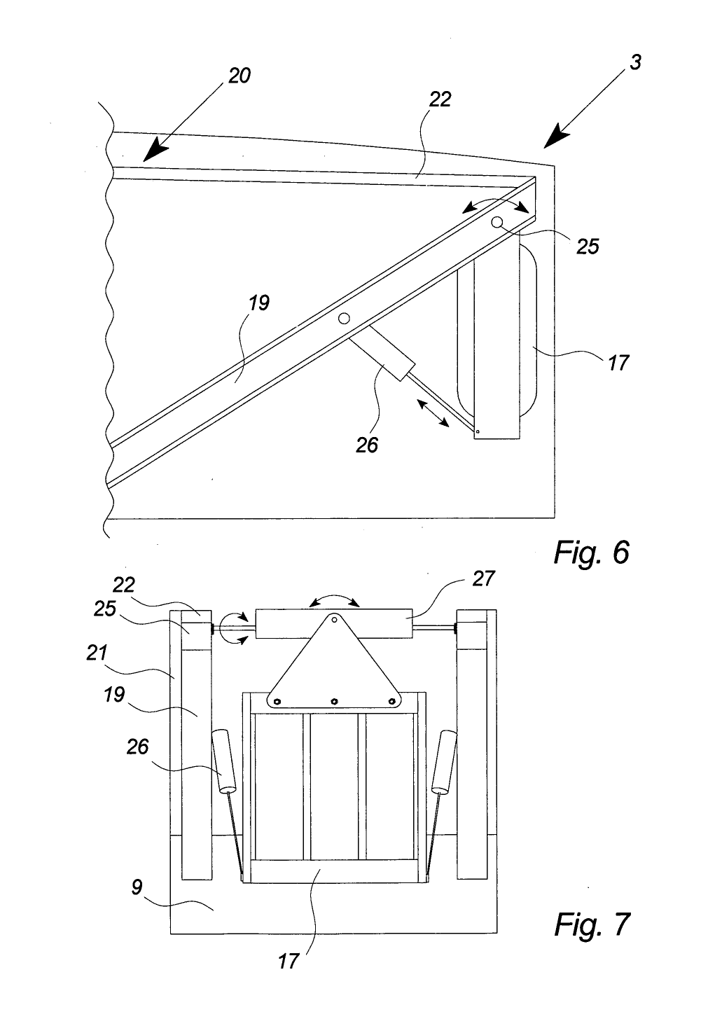

FIG. 6 illustrates a suspension arrangement for the transformer 17 on the strut member 19 of the load carrying structure in the wind turbine nacelle 3. The arrangement includes use of a pivoting connection means 24 and movement dampers or actuators 26 in attaching the transformer on the strut member 19.

The transformer may move back and forth in the longitudinal direction of the nacelle in response to nacelle vibrations but in a restricted manner by the movement dampers.

FIG. 7 illustrates a further embodiment of the suspension arrangement for the transformer 17, as seen from the rear of the nacelle, wherein the flexibility of the arrangement is enhanced by establishing a cardan functionality allowing the transformer to sway longitudinally and transversely (as illustrated with the arrows) in between the strut members 19 of the two closed structures.

Other flexible suspension arrangements including flexible joint connection in the suspension of the transformer such as cardan, ball or similar universal coupling joints may be used. Different embodiments are disclosed in co-pending Danish patent application filed 16 Dec. 2008 by the same applicant and titled “Wind turbine” and is hereby incorporated by reference.

The invention has been exemplified above with reference to specific examples of the invention. However, it should be understood that the invention is not limited to the particular examples described above but may be designed and altered in a multitude of varieties within the scope of the invention as specified in the claims.

### LIST

1. Wind turbine
2. Tower
3. Nacelle
4. Rotor
5. Blade
6. Hub
7. Foundation
8. Ground level
9. Bedframe or similar bell-shaped structure
10. Yaw mechanism
11. Lower beam
12. Upper beam
13. Connection beams
14. Gearbox
15. Electric generator
16. Power converter
17. Transformer for feeding generated power to the utility grid
18. Wind turbine component such as generator, power converter or transformer
19. Tie member,
20. Load carrying structure
21. Base member
22. Strut member e.g. one or more beams or cable stays
23. Connection for the strut member
24. Connection means for the wind turbine components
25. Shaft for attachment of wind turbine component
26. Movement dampers
27. Flexible suspension arrangement
hp. Horizontal plane

1. A wind turbine nacelle comprising
wind turbine components, and
a load carrying structure comprising:
a base member structurally establishing a connection between the wind turbine rotor and tower,
at least one tie member, and
at least one strut member carrying one or more of said wind turbine components, said wind turbine components being attached to said strut member so that the weight of said wind turbine components are converted to a force compressing said strut member,
wherein tie and strut members are connected at one end to each other and at the opposite ends to different positions on the base member for establishing one or more closed structures.

2. The wind turbine nacelle according to claim 1 wherein said one or more closed structure is triangular, substantially triangular in shape or at least has a triangular transfer of forces with said tie member as the upper triangle side.

3. The wind turbine nacelle according to claim 1 wherein said at least one tie member is one or more beams, cable stays or wires.

4. The wind turbine nacelle according to claim 1 wherein said strut member is inclined in relation to a horizontal plane by an angle α in a range of 15 to 75° such as approx. 45°.

5. The wind turbine nacelle according to claim 1 wherein the number of said at least one strut member is one centrally situated member in relation to the nacelle sides and orientated toward the rear of the nacelle.

6. The wind turbine nacelle according to any of claim 1 wherein the number of said at least one strut member is two members at the nacelle sides e.g. parallel in direction or orientated to meet at the rear of the nacelle.

7. The wind turbine nacelle according to claim 1 wherein one or more of electric generators, power converters and transformers are carried by said at least one strut member.

8. The wind turbine nacelle according to claim 1 wherein the transformer is suspended from said at least one strut member in a suspension arrangement including a shaft attachment and one or more movement dampers and/or actuators.

9. The wind turbine nacelle according to claim 8 wherein said suspension arrangement is suspended to said at least one strut member in a flexible joint connection and/or includes a flexible joint connection allowing the transformer to sway.

10. The wind turbine nacelle according to claim 9 wherein said flexible joint connection is a cardan, ball or similar universal coupling joint.

11. A wind turbine comprising a wind turbine nacelle according to any of claim 1.
